(19) United States
(12) Patent Application Publication
(10) Pub. No.: US 2004/0015635 A1
(43) Pub. Date: Jan. 22, 2004

(54) Data transfer controller with data pre-fetching function

(75) Inventors: Toshihiro Kawakami, Kato-gun (JP); Hajime Fujito, Kato-gun (JP); Shinichi Ogame, Kato-gun (JP); Tokuo Ikutomo, Kato-gun (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/614,211

(22) Filed: Jul. 8, 2003

(30) Foreign Application Priority Data
Jul. 18, 2002 (JP) 2002-210198

(51) Int. Cl. G06F 13/14

(52) U.S. Cl. 710/305

(57) ABSTRACT

A data transfer controller connects a high-speed bus to a low-speed bus. The controller includes an address register, a buffer, and a central controlling circuit. The address register stores an address allotted to a peripheral device connected to the low-speed bus. The stored address is referred to as preset address. The buffer stores a data retrieved from the peripheral device based on the preset address. The retrieved data is referred to as prefetched data. The central controlling circuit causes the prefetched data stored in the buffer to be outputted into the high-speed bus when a peripheral device address transmitted through the high-speed bus is identical to the preset address.

### BACKGROUND OF THE INVENTION

1. Field of the Invention

The present invention relates to a data transfer controller for use in a computer, for example. In particular, the present invention relates to a bus bridge for connecting two buses having different data transfer rates, and to an I/O controller for connecting an inner bus of a computer and a cable to be connected to a peripheral device.

2. Description of the Related Art

As is known, a computer incorporates a printed circuit board called “motherboard” that contains the principal components of the system and several connectors for other circuit boards to be slotted into. For providing the necessary wiring, the motherboard is formed with buses, such as a front side bus (FSB), a peripheral component interconnect (PCI) bus, and an industry standard architecture (ISA) bus. The FSB connects the CPU and the main memory of the computer, providing the fastest data transfer rate of the above three bus types. The PCI bus comes second in data transfer rate, and the ISA bus is the third. Between the FSB bus and the PCI bus is provided a host bridge enabling proper data transfer from the FSB to the PCI, or vice versa. A similar device called PCI/ISA bridge is provided for connecting the PCI bus and the ISA bus.

In the conventional system, data may be transferred through the bus lines in the following manner.

To retrieve a particular piece of data stored in an “ISA device” connected to the ISA bus, for example, the CPU first occupies the FSB. Then, the CPU sends out an “I/O port address” and a read access signal to the FSB. The I/O port address specifies an address of a control register in the ISA device at which the desired data is stored.

The I/O port address and the read access signal sent to the FSB bus are received by the host bridge. Upon receiving them, the bus master, i.e. the host bridge occupies the PCI bus. Then, after being converted to conform to the bus cycle of the PCI bus, the port address and the access signal are sent to the PCI bus.

Thereafter, the port address and the access signal are received by the PCI/ISA bridge. Upon this, the PCI/ISA bridge as a bus master occupies the ISA bus, converts the received address and signal to counterparts conforming to the bus cycle of the ISA bus, and sends them to the ISA bus. At this stage, the desired data is read out from the specified control register of the ISA device, to be sent to the PCI/ISA bridge through the ISA bus. Finally, the data is transferred through the PCI bus and then the FSB, to be brought to the CPU.

Unfavorably, the above conventional data fetching scheme tends to take a rather long time when the desired data is stored in an ISA device connected to the ISA bus. This is because the data transfer rate of the ISA bus is significantly slow (e.g. 4 MB/s) in comparison with that of the PCI bus (e.g. 130 MB/s) or that of the FSB (e.g. 2 GB/s), and the overall data-fetching speed is greatly affected by the slowest ISA bus.

### SUMMARY OF THE INVENTION

The present invention has been proposed under the circumstances described above. It is, therefore, an object of the present invention to provide a data transfer controller or controlling method that reduces the overall data-fetching time.

According to a first aspect of the present invention, there is provided a data transfer controller connecting a high-speed bus having a relatively high data transfer rate to a low-speed bus having a relatively low data transfer rate. The controller comprises: an address register for storing an address allotted to a peripheral device connected to the low-speed bus, the stored address being referred to as a preset address; a buffer for storing a data retrieved from the peripheral device based on the preset address, the retrieved data being referred to as prefetched data; and a central controller for causing the prefetched data stored in the buffer to be outputted into the high-speed bus when a peripheral device address transmitted through the high-speed bus is identical to the preset address.

Preferably, the address register may hold an address having relatively high access frequency.

Preferably, the high-speed bus and the low-speed bus may be arranged within a computer.

Preferably, the high-speed bus may be arranged within a computer, while the low-speed bus may be a cable arranged outside of the computer.

According to a second aspect of the present invention, there is provided a method of transferring data between a high-speed bus having a relatively high data transfer rate and a low-speed bus having a relatively low data transfer rate. The method comprises the steps of: storing an address allotted to a peripheral device connected to the low-speed bus, the stored address being referred to as a preset address; storing a data retrieved from the peripheral device based on the preset address, the retrieved data being referred to as prefetched data; and causing the stored prefetched data to be outputted into the high-speed bus when a peripheral device address transmitted through the high-speed bus is identical to the preset address.

Other features and advantages of the present invention will become apparent from the detailed description given below with reference to the accompanying drawings.

### BRIEF DESCRIPTION OF THE DRAWINGS

FIG. 1 shows an example of bus connection involving a data transfer controller according to the present invention;

FIG. 2 shows the principal components of the data transfer controller of the present invention;

FIGS. 3 and 4 illustrate the workings of the data transfer controller of the present invention; and

FIG. 5 shows an example of a computer system to which the present invention is applicable.

### DETAILED DESCRIPTION OF THE PREFERRED EMBODIMENTS

Preferred embodiments of the present invention will be described below with reference to the accompanying drawings.

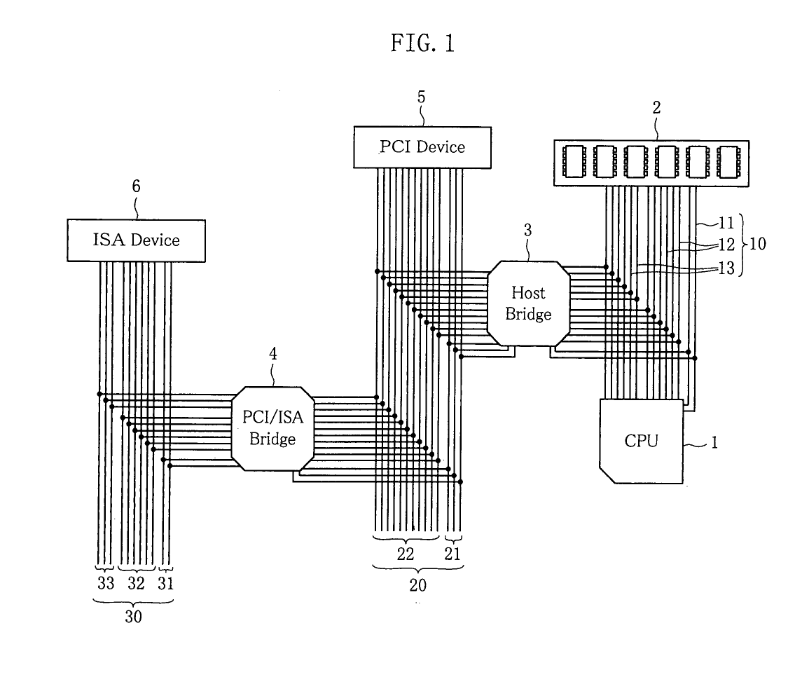

FIG. 1 shows an example of bus connection arrangement involving a data transfer controller according to the present invention. The illustrated buses are FSB 10, PCI bus 20 and ISA bus 30. Typically these buses are formed on the mother board of a personal computer, for example. As shown, the FSB 10 connects a CPU 1 and a main memory 2. The PCI bus 20 is connected to a PCI device 5, while the ISA bus 30 is connected to an ISA device 6. Though not depicted in the figure, some other PCI devices or ISA devices may be connected to the PCI bus 20 or the ISA bus 30. Regarding the data transfer rate, the FSB 10 is the fastest, the PCI bus 20 is the second, and the ISA bus 30 is the slowest. The FSB 10 and the PCI bus 20 are bridged by a host bridge 3 for controlling the mutual data transfer from one bus to the other. Likewise, the PCI bus 20 and the ISA bus 30 are bridged by PCI/ISA bridge 4 having the same function as the host bridge 3.

The FSB 10 provides a parallel data transfer passage operating in synchronism with the base clock (external clock) on the mother board. Specifically, the FSB 10 includes control lines 11 for sending control signals (e.g. read/write access commands), address lines 12 for sending address signals, and data lines 13 for sending data. The bus clock of the FSB 10 may be 100-200 MHz, and the maximum data transfer rate may be about 2 GB/s.

The PCI bus 20 provides parallel data transfer passage between the PCI device 5 and the host bridge 3, or between the PCI device 5 and the PCI/ISA bridge 4. The PCI bus 20 includes control lines 21 for sending control signals, and address/data lines 22 for sending both address signals and data. The bus width of the address/data lines 22 may be 32 bits. The maximum bus clock of the PCI bus 20 may be 33 MHz, and the maximum data transfer rate may 132 MB/s.

The ISA bus 30 provides parallel data transfer passage between the ISA device 6 and the PCI/ISA bridge 4. The ISA bus 30 includes control lines 31 for sending control signals, address lines 32 for sending address signals, and data lines 33 for sending data. The bus width of the address lines 32 may be 24 bits, while the bus width of the data lines 33 may be 16 bits. The maximum bus clock of the ISA bus 30 may be 8 MHz, and the maximum data transfer rate may 4 MB/s.

The CPU 1 reads or writes data to the peripheral devices such as the main memory 2, the PCI device 5, and the ISA device 6. For this purpose, the CPU 1 occupies the FSB 10 as the bus master, to send a read/write access signal into the control lines 11 of the FSB 10. At the same time, the CPU 1 sends into the address lines 12 an address signal that specifies the location of the desired data in the “target device” (i.e. the selected one of the peripheral devices 2, 5 and 6 for the required data reading or writing operation). With respect to the memory 2, the specifying of the data location is performed on the basis of an allotted memory address. For the PCI device 5 and the ISA device 6, the same is performed on the basis of an allotted I/O port address.

The memory 2 is provided with a plurality of data storage regions each of which has a unique address allotted. When one of the addresses is specified by e.g. the CPU 1, data is written to the relevant data storage region, or previously stored data is read out from the storage region.

The PCI device 5 may be an IDE (integrated device electronics) hard disk drive, a NIC (network interface card), a SCSI (small computer system interface) device, or a graphics accelerator, for example. Though slower than the main memory 2, the PCI device 5 is a relatively fast device in terms of data input/output rate. Generally PCI devices are categorized into two types. One of them is a riser card type that can be inserted into an extension slot provided on the PCI bus, while the other type can be connected to the PCI bus via an I/O controller. The PCI device 5 incorporates a microcomputer, associated peripheral circuits, and control registers, for example. The above-mentioned I/O port address is allotted to each of the control registers.

The ISA device 6 may be an FDD (flexible disk drive), an RS-232C device, a printer, or a keyboard, for example. The ISA device 6 is slower in data input/output rate than the PCI device 5. As in the PCI device 5, the ISA device 6 is categorized into a riser card type or an I/O controller type. The ISA device 6 also incorporates a microcomputer, associated peripheral circuits, and I/O port address-allotted control registers, for example.

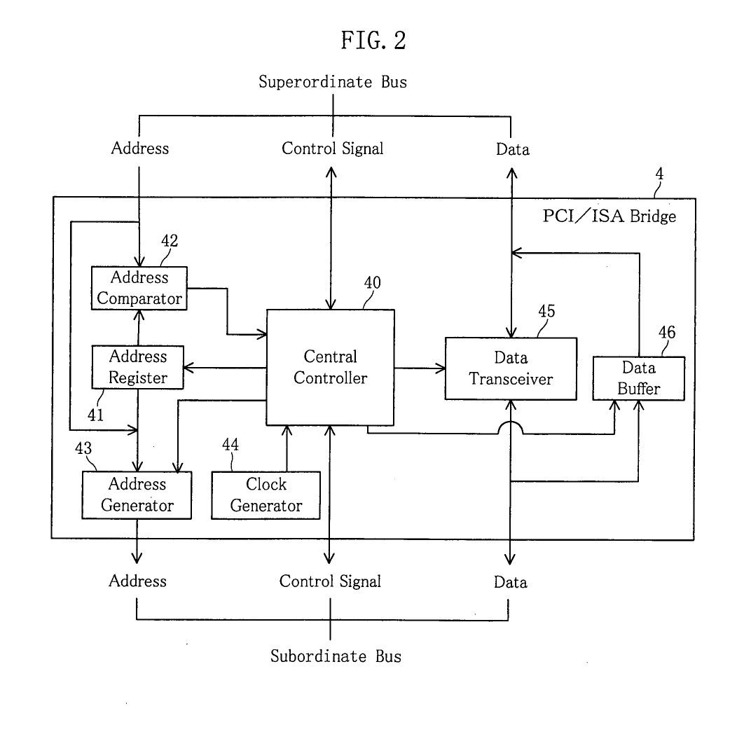

Referring to FIG. 2, the inner circuit design of the PCI/ISA bridge 4 will now be described. It should be appreciated that the host bridge 3 is basically the same in inner circuit design as the PCI/ISA bridge 4. Thus, the explanation about the host bridge 3 is omitted.

As shown in FIG. 2, the PCI/ISA bridge 4 incorporates a central controller 40, address registers 41, an address comparator 42, an address generator 43, a timer clock generator 44, a data transceiver 45, and a data buffer 46, for example. The overall operation of the bridge 4 is controlled by the central controller 40. One of the most advantageous features of the bridge 4 is the “data prefetching function” to be described below.

From the perspective of the PCI/ISA bridge 4, the PCI bus 20 is regarded as a superordinate bus, while the ISA bus 30 is regarded as a subordinate bus. The control lines 21 of the superordinate bus 20 are connected to the central controller 40, while the address/data lines 22 are connected to the address comparator 42, the data transceiver 45, or the data buffer 46. On the other hand, the control lines 31 of the subordinate bus 30 are connected to the central controller 40, the address lines 32 to the address generator 43, and the data lines 33 to the data transceiver 45 as well as to the data buffer 46. The PCI/ISA bridge 4 can be a master of the subordinate bus, or ISA bus 30.

In operation, the central controller 40 performs many functions as required. For example, the controller 40, upon receiving a read/write access signal for the ISA device 6, converts the signal into an appropriate counterpart signal conforming to the bus cycle of the ISA bus 30. Then, the controller 40 outputs the converted signal into the control lines 31 of the ISA bus 30.

The address register 41 stores “preset addresses” that are required for performing the “prefetching function” to be described later. The “preset addresses” may be the I/O port addresses allotted to the FDD, the RS-232C device, the printer and the keyboard connected to the ISA bus 30. It should be noted here that the address register 41 does not necessarily store all the I/O port addresses of the respective ISA devices connected to the ISA bus 30. For economy of the memory space, only the I/O port addresses of some selected ISA devices may be stored as the preset addresses. The selection may be made based on simulation experiments conducted for analyzing access patterns with respect to the ISA devices 6. In this case, if some ISA devices are found to be accessed more frequently than the others, the I/O port addresses of these particular devices may be stored in the address register 41 as the preset addresses.

The address comparator 42 makes a comparison between an address supplied through the address/data lines 22 of the PCI bus 20 and the preset addresses stored in the address register 41. The result of the comparison is sent to the central controller 40.

The address generator 43 operates in accordance with the instructions from the central controller 40, to generate “address data” corresponding to an address supplied through the address/data lines 22, or to a preset address stored in the address register 41. After being processed for conformity to the bus cycle of the ISA bus 30, the address data is outputted from the address generator 43 through the address lines 31 of the ISA bus 30.

The timer clock generator 44 generates a timer clock signal based on which the data prefetching of the present invention is periodically performed. The generated clock signal is supplied to the central controller 40. At the timing regulated by the clock signal, the central controller 40 sends an instruction to the address generator 43. Upon receiving the instruction, the generator 43 causes a relevant preset address stored in the register 41 to be outputted into the address lines 31 of the ISA bus 30. Since the instruction from the controller 40 is issued periodically in accordance with the clock signal, the relevant preset address is outputted periodically into the address lines 31.

The data transceiver 45 serves as a conduit for data to be transmitted from the address/data lines 22 of the PCI bus 20 to the data lines 33 of the ISA bus 30, and vice versa. Before transmitted from one bus to the other, the data is subjected to conversion for conformity to the bus cycle of the other bus lines.

The data buffer 46 stores “prefetched data” obtained in advance from a selected ISA device 6. The prefetched data is outputted into the address/data lines 22 of the PCI bus 20 under the control of the central controller 40 when an address referenced through the PCI bus 20 matches the preset address relevant to the prefetched data.

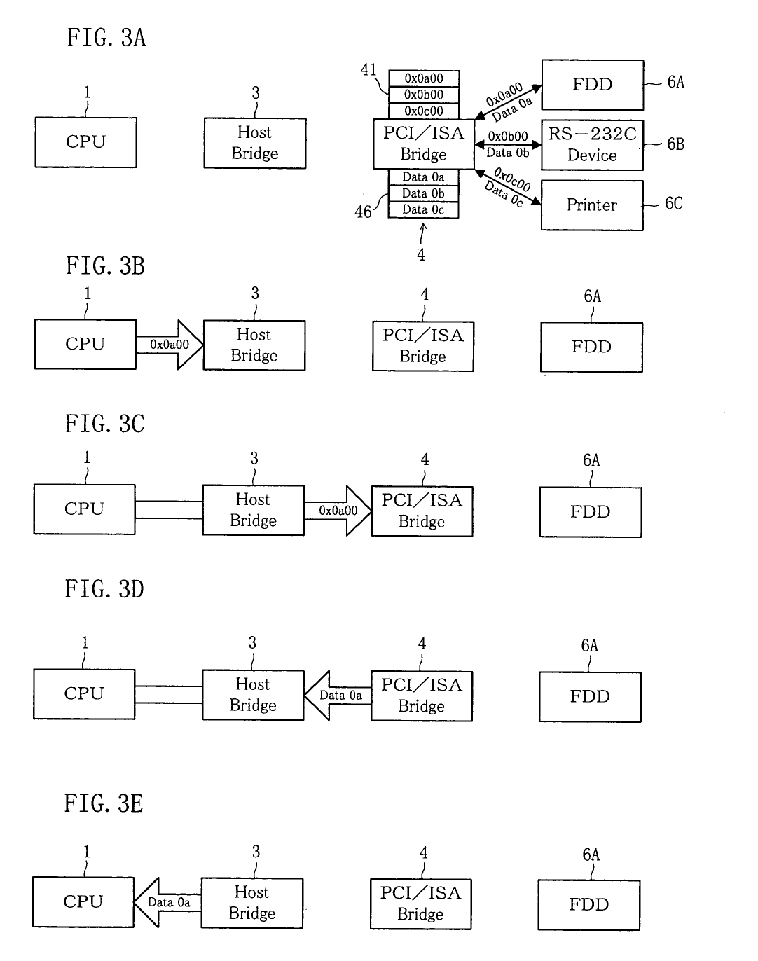

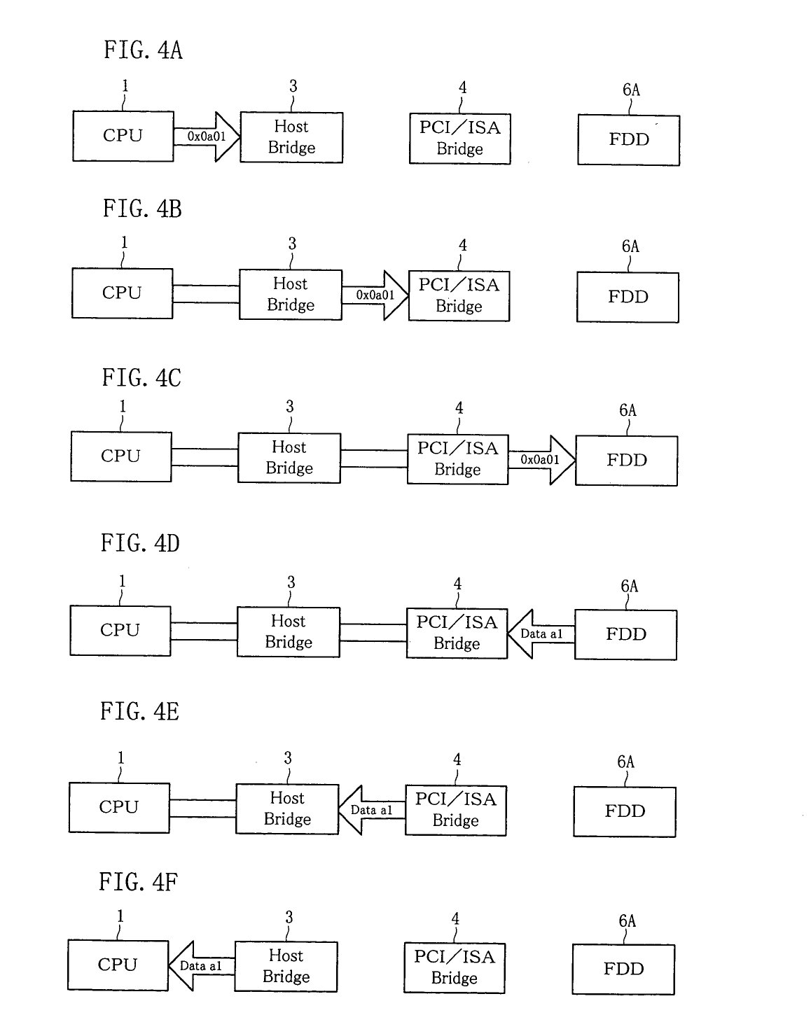

Referring now to FIGS. 3 and 4, the data prefetching of the present invention will be described below.

As shown in FIG. 3A, when there is no read/write access from the CPU 1 (see also FIG. 1), the PCI/ISA bridge 4 occupies the ISA bus 30 for performing periodical data prefetching operation with respect to the ISA devices 6. More specifically, the central controller 40 of the bridge 4 outputs read access signals into the ISA bus 30 at the timing regulated by the timer clock signal. Together with the access signals, the bridge 4 also sends out the preset addresses (stored in the register 41) into the ISA bus 30. In the illustrated example, preset addresses “0x0a00”, “0x0b00” and “0x0c00” are sent to the FDD 6A, the RS-232C device 6B and the printer 6C, respectively.

In each ISA device 6A-6C receiving the read access signal, the required data is read out from the control register corresponding to the preset address, and then sent to the bridge 4 via the ISA bus 30. In the illustrated example, data “0a”, “0b” and “0c” are retrieved from the FDD 6A, RS-232C device 6B and the printer 6C, respectively. These individual pieces of data are stored in the data buffer 46.

The above-described data prefetching is repeated in accordance with the clock signal to update the data stored in the buffer 46.

Referring to FIG. 3B, when the CPU 1 occupies the FSB 10 and issues a read access signal together with a data address for one of the ISA devices 6 (the FDD 6A, for example), the access signal and the address are sent to the host bridge 3 via the FSB 10.

Then, as shown in FIG. 3C, the host bridge 3 occupies the PCI bus 20 to send the read access signal and the data address to the PCI/ISA bridge 4.

Then, the address comparator 42 of the bridge 4 compares the supplied data address with the preset addresses stored in the address register 41 to check if there is any match. In the illustrated example, the preset addresses include the address “0x0a00” of the FDD 6A, and the corresponding data “0a” has been prefetched. In this situation, as shown in FIG. 3D, the desired data can be outputted immediately from the bridge 4 to the host bridge 3, whereby there is no need to proceed to the FDD 6A to obtain the data.

Finally, as shown in FIG. 3E, the data from the PCI/ISA bridge 4 is forwarded to the CPU 1 via the host bridge 3. After the data is received by the CPU 1, the read access procedure is over, whereby the FSB 10 and the PCI bus 20 are relieved.

According to the above data prefetching scheme, the desired data in the ISA device 6 has been stored in the PCI/ISA bridge before the data is actually required. Thus, the memory access time is advantageously shortened.

Referring to FIGS. 4A-4F, when the data address issued from the CPU 1 is not found in the preset addresses stored in the PCI/ISA bridge 4 (“0x0a01” in the illustrated example), the bridge 4 occupies the ISA bus 30 (FIG. 4C), to send the read access signal and the memory address to the target ISA device 6A. Thereafter, as shown in FIG. 4D, the required data (“a1” in the example) is read out from the ISA device 6 to be sent to the bridge 4. The data received by the bridge 4 is forwarded to the CPU 1 via the host bridge 3, as shown in FIGS. 4E and 4F.

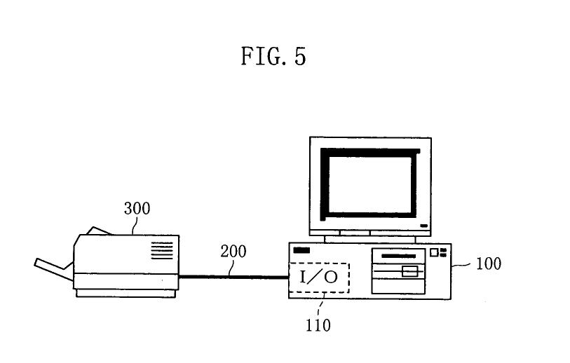

The data transfer controller of the present invention can be used for other applications than the above-described bus connection on the mother board. Referring to FIG. 5, for instance, the data transfer controller may be incorporated in the I/O interface 110 for connecting the internal buses of the computer main unit 100 to the cable 200 (i.e. the external bus) connected to a printer 300.

According to the present invention, the preset addresses stored in the address register 41 may be periodically replaced with other ones, depending on the data access patterns of the currently running program. In this case, the PCI/ISA bridge 4 may be provided with a “logon data obtaining function” based on the previous data access patterns, whereby the obtained logon information is used for determining which of the old preset addresses is to be replaced by a new one frequented by the user of the computer.

As previously noted, the host bridge 3 has the same data prefetching function as the PCI/ISA bridge 4. Thus, the desired data may be prefetched by the bridge 4 from the PCI device 5. In this case again, the memory access time can be reduced than otherwise.

The read access command may not necessarily be issued from the CPU 1. For instance, when the host bridge 3 incorporates a DMA (direct memory access) controller, for example, the read access command may be issued from the DMA controller.

The address register 41 may be designed to store two or more preset addresses for any one of the ISA devices 6.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A data transfer controller connecting a high-speed bus having a relatively high data transfer rate to a low-speed bus having a relatively low data transfer rate, the controller comprising:
an address register for storing an address allotted to a peripheral device connected to the low-speed bus, the stored address being referred to as a preset address;
a buffer for storing a data retrieved from the peripheral device based on the preset address, the retrieved data being referred to as prefetched data; and
a central controller for causing the prefetched data stored in the buffer to be outputted into the high-speed bus when a peripheral device address transmitted through the high-speed bus is identical to the preset address.

2. The data transfer controller according to claim 1, wherein the address register holds an address having relatively high access frequency.

3. The data transfer controller according to claim 1, wherein the high-speed bus and the low-speed bus are arranged within a computer.

4. The data transfer controller according to claim 1, wherein the high-speed bus is arranged within a computer, the low-speed bus being a cable arranged outside of the computer.

5. A method of transferring data between a high-speed bus having a relatively high data transfer rate and a low-speed bus having a relatively low data transfer rate, the method comprising the steps of:
storing an address allotted to a peripheral device connected to the low-speed bus, the stored address being referred to as a preset address;
storing a data retrieved from the peripheral device based on the preset address, the retrieved data being referred to as prefetched data; and
causing the stored prefetched data to be outputted into the high-speed bus when a peripheral device address transmitted through the high-speed bus is identical to the preset address.
